(19) United States
(12) Patent Application Publication
(10) Pub. No.: US 2011/0307292 A1
(43) Pub. Date: Dec. 15, 2011

(54) System and Method for Analysis and Visualization of Emerging Issues in Manufacturing and Supply Chain Management

(75) Inventors: Andrew B. Waldo, Bethesda, MD (US); Patrick B. Waldo, Bethesda, MD (US)

(73) Assignee: Decernis, LLC, Washington, DC (US)

(21) Appl. No.: 13/156,917

(22) Filed: Jun. 9, 2011

Related U.S. Application Data
(60) Provisional application No. 61/352,927, filed on Jun. 9, 2010.

(51) Int. Cl. G06Q 10/00

(52) U.S. Cl. 705/7.27

(57) ABSTRACT

An apparatus and method is provided for compliance management system for use in, for example, a food-related supply chain, manufacturing, processing and distribution of a product that might also be a consumer product, as well as an industrial chemical or article. The user may be one engaged in the production of the commodity or a governmental agency, association, or service provider. The apparatus includes a database system and hardware for collection of regulatory and/or industry-related event information from a News Aggregator, analysis of trends discernable from the event information, and presentation of the trend information in a manner which permits user visualization of the trends to permit timely response to the developing trend in product manufacturing and supply chain management. The trend analyses may be distributed as an electronic network service to participants of a network and supply chain affected by the discovered trends.

### BACKGROUND OF THE INVENTION

The present invention discloses an apparatus and method for the analysis and visualization of emerging issues in manufacturing and supply chain management.

The need to be well informed of significant events that may affect the manufacture, processing, distribution, and sale of foods, consumer products, pharmaceutical and biological products, and industrial products is critical to success in a global market of increasing complexity. Just as a financial analyst requires a means of analyzing market and portfolio trends through a visualization of trends in order to identify patterns of interest a manufacturer needs the capability to analyze and visualize trends in developments relating to emerging issues that relate to the manufacture, distribution, and sale of goods, such as foods, drugs, biologics, consumer products, and industrial products. However, unlike a financial analysis of a stock portfolio a manufacturer requires information about emerging issues related to health issues, such a toxicological studies of carcinogenicity in a topical area such as animal feeds, as well as trends relating to specific raw materials, products, and commodities. To address these needs there are well known methods of establishing key performance indicators for internal manufacturing, but these do not address the linkage between internal processes and materials with external issues as they develop through global regulatory and scientific events. What is needed is a method of analyzing and visualizing timely regulatory and scientific developments in order to identify emerging issues, patterns, and trends necessary to the control of a business or manufacturing process. The present invention provides an apparatus and method for these purposes among others.

It is desirable for the manufacturer to have a means to analyze the development of emerging issues. For example, it may be related to a substance used in a company's food processing. A case in point is a substance, Methyl Eugenol, which has been identified by a number of agencies internationally as a potential carcinogen. Methyl eugenol, however, is a common component of spices. Thus the identification of a trend in the professional literature or in proposed actions by regulatory agencies expressing concern about the chronic health hazards of this substance should trigger an analysis of all downstream users and processors of the substance. Thus in this instance, a food processor desires to have a trend analysis for substances being used that relate to topics of concern, such as chronic health hazards, restrictions, approvals, performance, and properties. The analysis of the frequency, time-series, geographical areas of review is critical to improving the response of the manufacturer. If the manufacturer uses Alum in pickles and scientific studies begin to link Alum to Alzheimer's disease then the manufacturer needs to spot those trends as early as possible, determine the trends applicable to alternative materials, and then determine the consequences for its business process.

This is analogous to the analysis of the stock analyst who must decide on which equities to purchase and sell and who relies on both market trends and specific stock trends to make a determination. However, the methods and means of performing the analysis for the manufacturer who must make decisions about a formulation are entirely different. The analysis of a financial asset—even if complex—ultimately related to a single concept: Value. Here the manufacturer must make a nuanced multi-dimensional decision based on different elements defining safety, such as acute hazard, chronic hazard, performance, and global restrictions that differ from country to country.

Further, the analysis of trends applicable to a substance differ in that they apply to generic chemical families and food groups. For example, a toy manufacturer would be interested in any developments relating to phthlates as a chemical family. Further structure activity relationships as applied to emerging issues do not have a similar aspect in the financial world. With regard to food groups, a manufacturer of an orange juice is interested in any scientific and regulatory developments relating to citrus as a food group as well as to the specific commodity.

It is desirable for a manufacture be able to relate the trends both with regard to her or her specific manufacturing process, to general industry trends, and to trends affecting his supply chain and to best practices identified by industry, standard, and regulation.

The invention provides for a more effective and timely approval of materials used in a supply chain with the benefits of reduced time, increased accuracy of information.

Other objects, advantages and novel features of the present invention will become apparent from the following detailed description of the invention when considered in conjunction with the accompanying drawings.

### BRIEF DESCRIPTION OF THE DRAWINGS

FIG. 1 illustrates results of a News Aggregation service for analyzing developments relating to a specific substance or commodity in accordance with an embodiment of the present invention.

FIG. 2 illustrates personalization of results of a New Aggregation service for trends applicable to specific user interests in accordance with an embodiment of the present invention.

FIG. 3 illustrates user definition of issues based on analysis of results of a News Aggregation service in accordance with an embodiment of the present invention.

FIG. 4 illustrates an approach to visualization of a trend in regulation and/or standards in accordance with an embodiment of the present invention.

FIG. 5 illustrates an approach to visualization of a trend in regulation and/or standards in accordance with an embodiment of the present invention.

FIG. 6 illustrates an approach to presentation of regulation and/or standards issues trends in regulation and/or standards in accordance with an embodiment of the present invention.

FIG. 7 illustrates a further approach to visualization of a trend in regulation and/or standards in accordance with an embodiment of the present invention.

FIG. 8 illustrates yet another approach to visualization of a trend in regulation and/or standards in accordance with an embodiment of the present invention.

### DETAILED DESCRIPTION OF THE INVENTION

An embodiment of the invention for the compliance management system includes a database system and hardware apparatus that includes a composition management system and hardware apparatus to store the product-component-raw material information, a database management system and hardware apparatus to collect the trend information from a News Aggregator, a series of trend analysis functions, and an output device. In a further embodiment of the invention, the output device is connected to a network and service application to distribute, search, and display trends personalized to the requirements of the user. In another embodiment of the invention, the trend analyses are distributed as a service to participants of a network and supply chain.

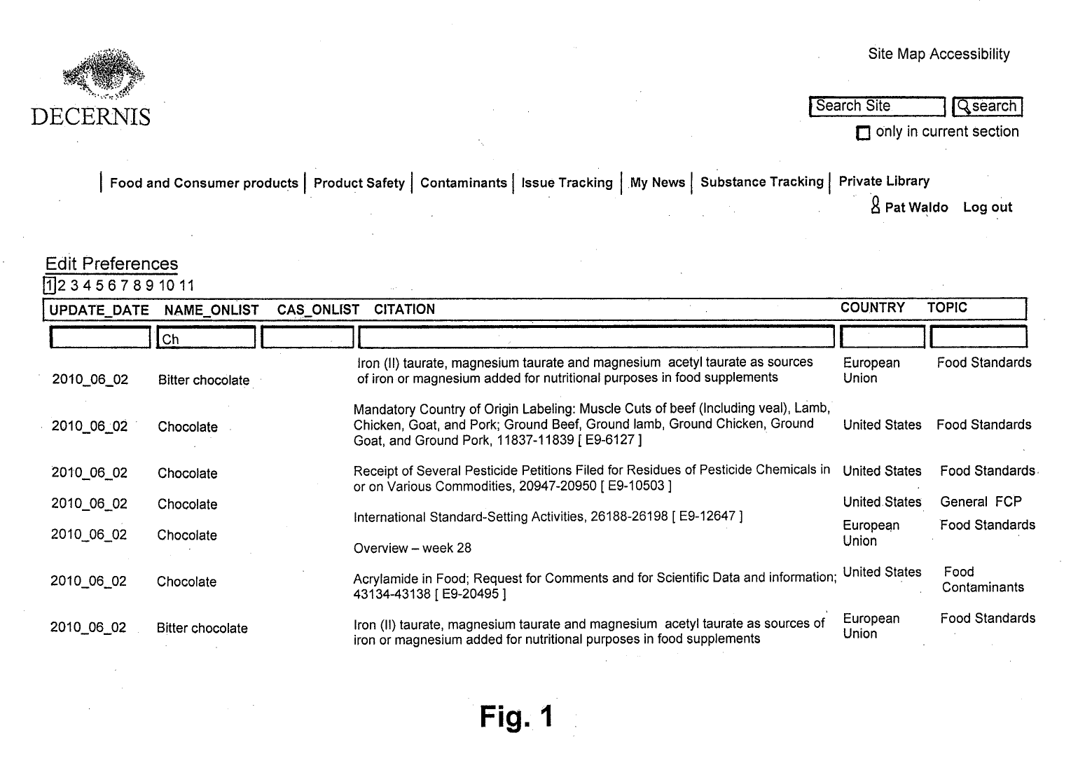

FIG. 1 illustrates how the results of a News Aggregation service may be taken in order to analyze the developments relating to a specific substance or commodity, in this case, chocolate. Such trends may be analyzed with regulatory to a geographical area, jurisdiction, type of action, topic, time, function or category or group of substance and commodity. In the example, two commodities, chocolate and bitter chocolate are related, but it might have been a chemical family, such as hexavalent chromium compounds, composed of a series of members, or a broad commodity group, such a citrus, or a functional group, such as flavors.

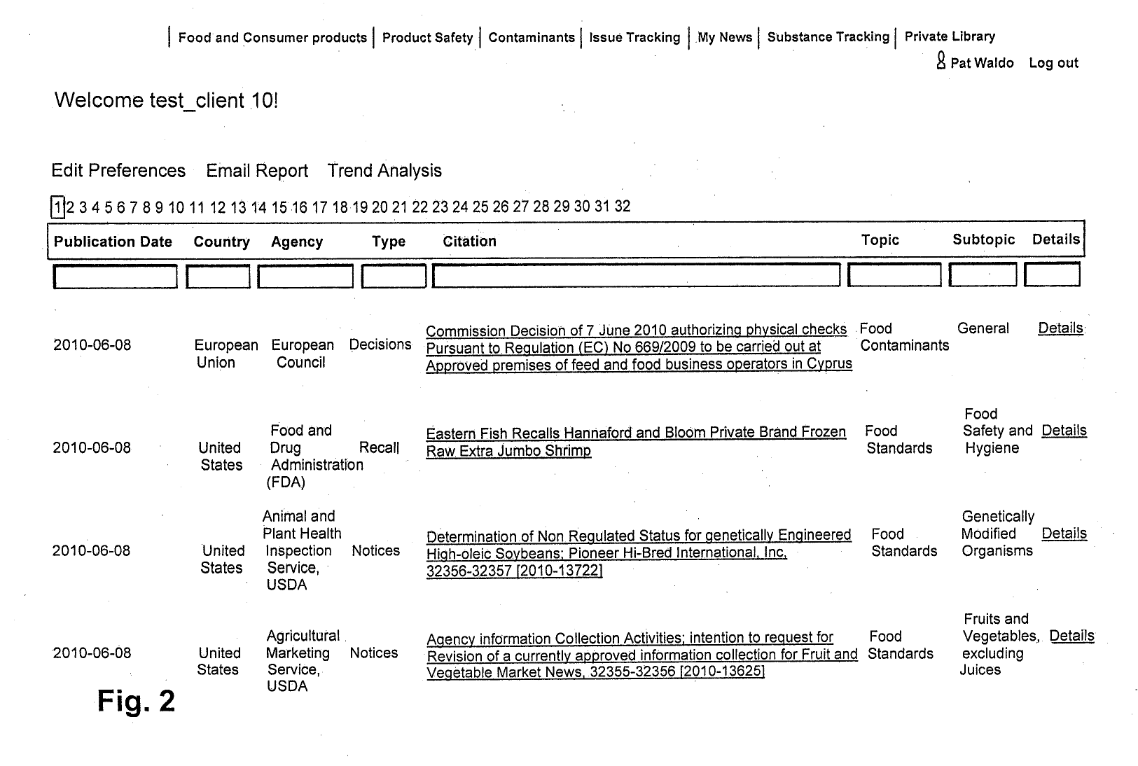

FIG. 2 illustrates how such results can be personalized to define trends and emerging issues applicable to the direct interests of the user.

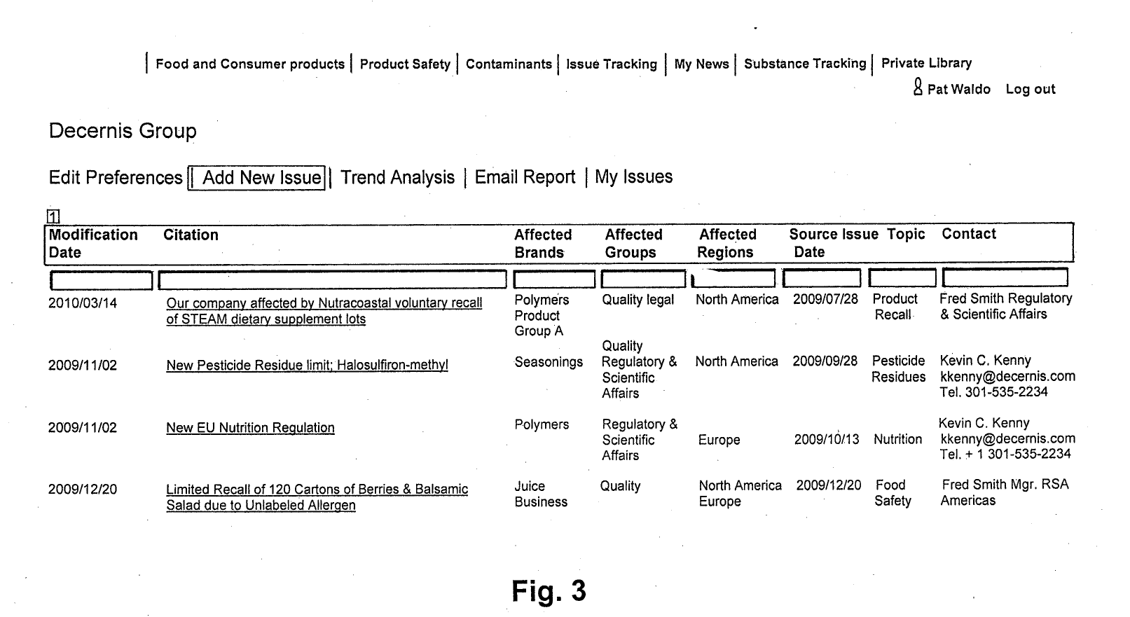

FIG. 3 illustrates how the user might define issues from a News Aggregation service as a result of the trends and developments presented. In this case, this case, the user has analyzed and acted upon the information to define an issue of concern and to establish a work program to resolve the issue.

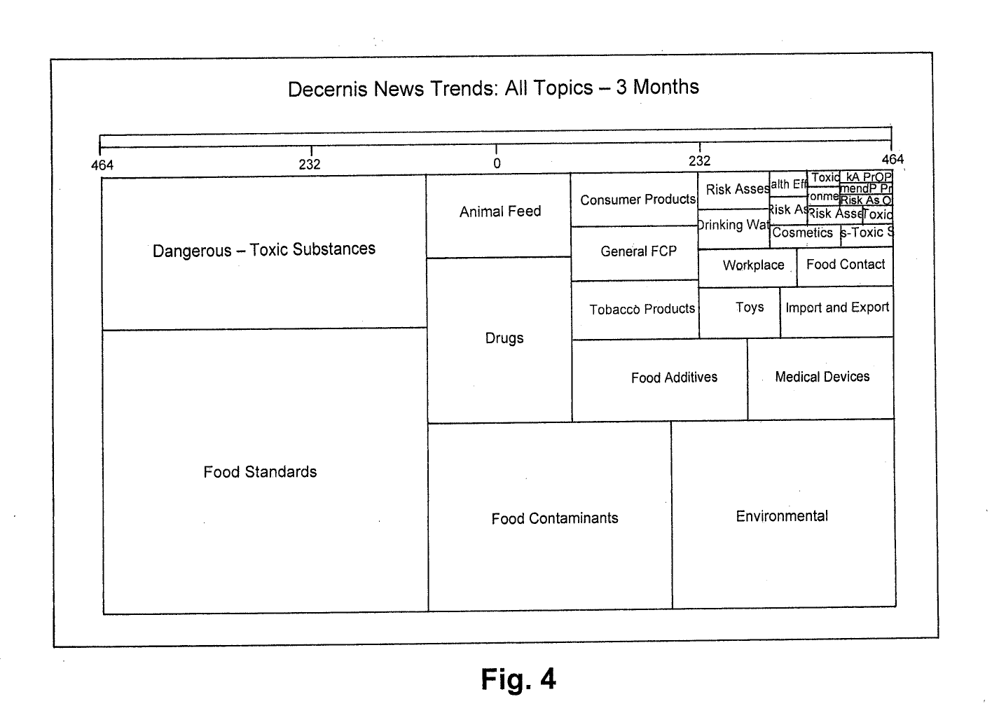

FIG. 4 illustrates how the results of a News Aggregation service may be taken through the apparatus of the present invention to define and visualize a trend or pattern. The intensity of the colors and the size of the boxes relate to the type of analysis provided within the present invention. In this case, the visualization applies to the frequency of all news events gleaned from the News Aggregation service.

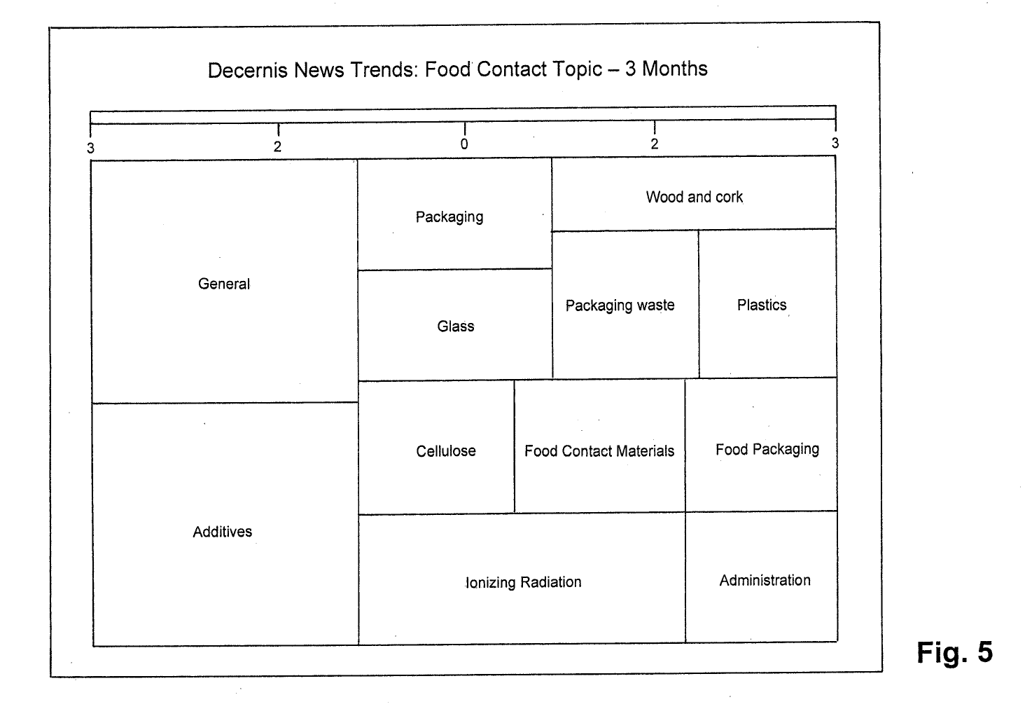

Referring to FIG. 5, the user may wish to compare such a general pattern to developments within a specific area, topic, substance group or functional class or in comparison to the users substances over time or at a particular time. The illustration depicts the pattern of developments taken from the News Aggregation service for Food Contact “events” over a three month period. Such events might be proposed regulations, scientific developments, or results from the general media, or comparisons between any of these. Often, for example, trends of material control emerge from particular areas. The Nordic Countries and some states of the United States, are often perceived as leaders in taking action on health and safety issues. A geographical analysis of trends that emerge from such leader jurisdictions is important in determining the actions that an organization should take.

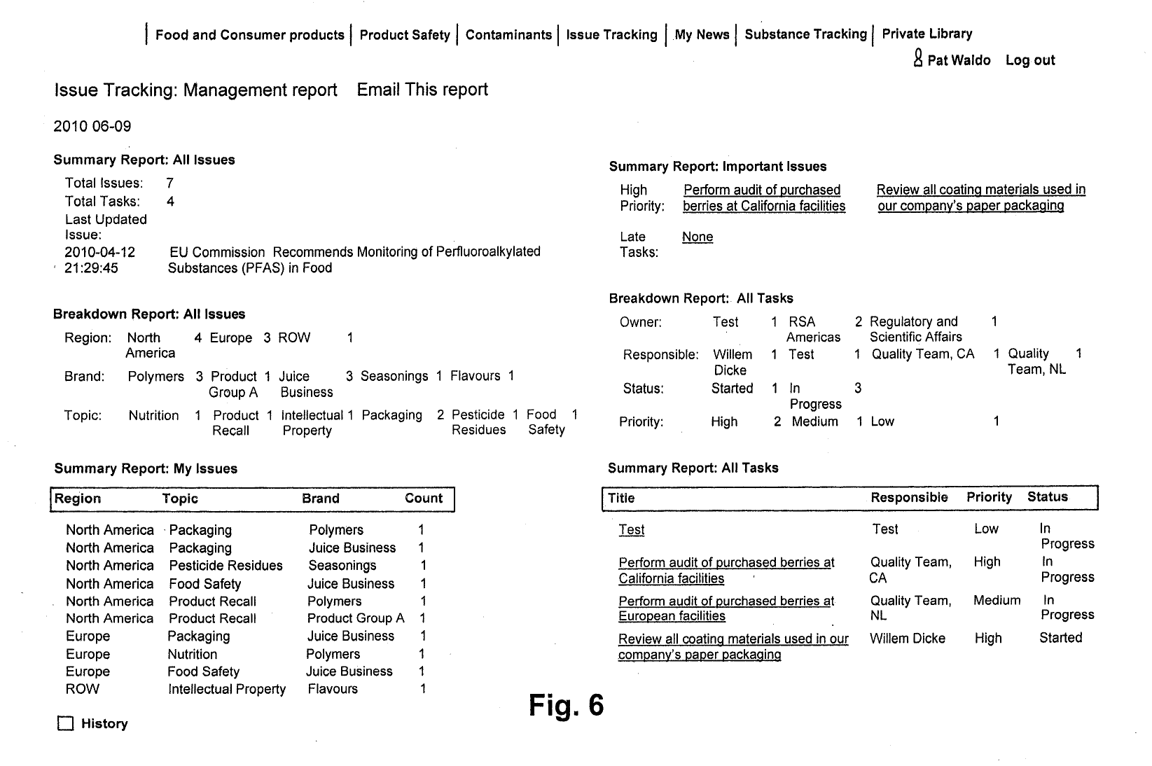

FIG. 6 illustrates a different kind of trend analysis where the customized presentation allows the user to break down those issues that have been identified by the user as of particular relevance and the actions being taken.

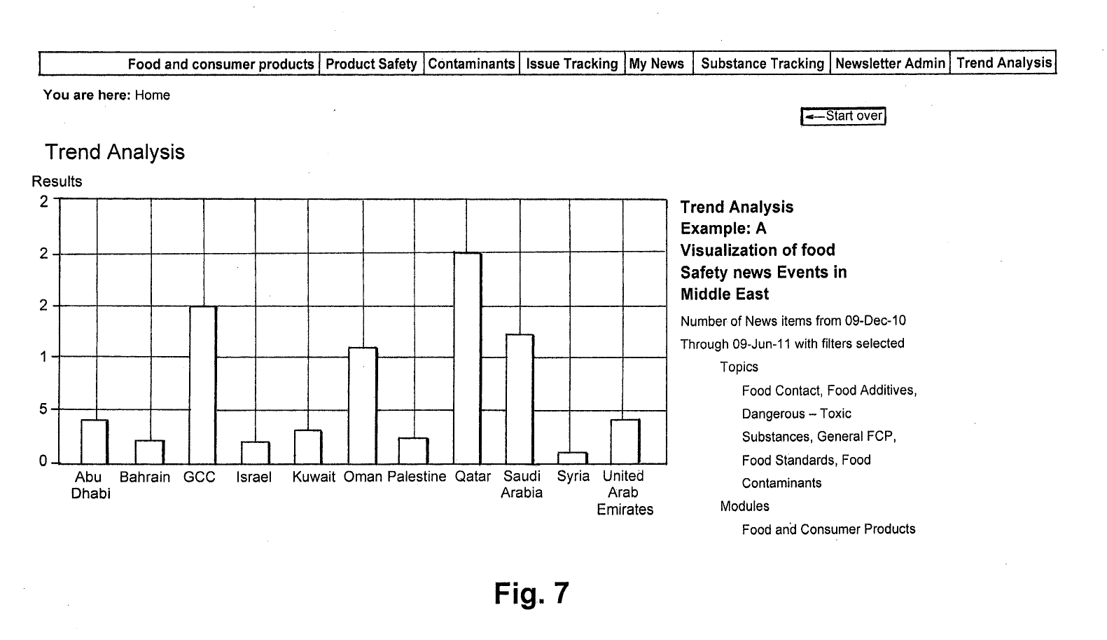

FIG. 7 illustrates an alternative graphical presentation of issue trend information in which the number of events involving one or more issue of interest (such as the issuance of a new regulatory requirement for fruit packaging or establishment of an industry standard or “best practice” with respect to content limits hazardous compound content in food products) are presented by the system hardware in a graph which charts the number of such events identified by the News Aggregation service by the country (or alternatively, the geographic region) in which the events were identified. Such a graphical presentation permits a user to identify trends in activity by country or region in a more timely manner and take action as required to respond to the emerging trend.

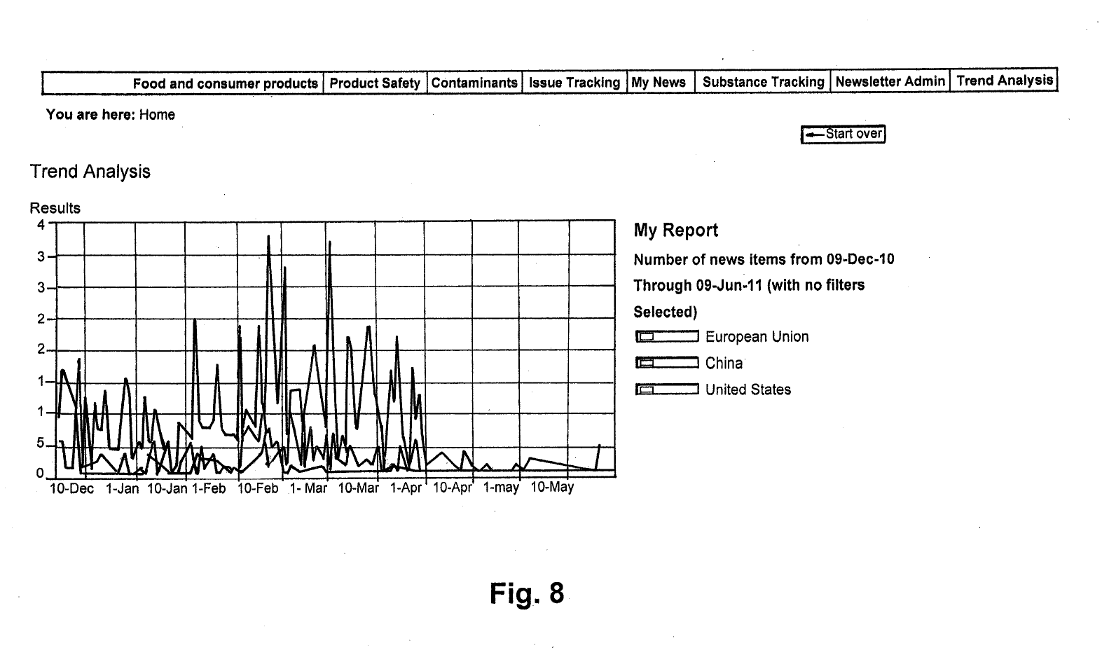

Referring to FIG. 8, this figure also illustrates an alternative graphical presentation of issue trend information, in this embodiment by presentation by the system hardware of a graphical representation of the frequency of occurrence of events of interest relevant to Substance A against time alongside a graphical representation of the frequency of occurrence of events of interest relevant to Substance B. Such a representation permits a user to identify trends in activity concerning specific substances in a timely manner and take action as required to respond to the emerging trend.

The present invention provides for a more standard means of analyzing and visualizing trends in the manufacture, processing, distribution and sale of goods by any actor with an interest. Providing more standard means of identifying and acting on emerging issues will provide a safer, more effective supply chain, enabling all actors to respond at an earlier time to general or specific trends. Further, the present invention enables the development of services and further types of analyses built upon the capabilities of the present invention to provide more effective controls of manufacturing and supply chain transactions.

The foregoing disclosure has been set forth merely to illustrate the invention and is not intended to be limiting. Because modifications of the disclosed embodiments incorporating the spirit and substance of the invention may occur to persons skilled in the art, the invention should be construed to include everything within the scope of the appended claims and equivalents thereof.

What is claimed is:

1. A method for computer-based issue analysis and trend visualization in at least one of manufacturing and supply chain management, comprising the steps of:
receiving at a network computer of a user a plurality of user-focused notifications of the existence of a developments relating to at least one of a substance and a product, wherein the developments include at least one of developments in a regulation, a standard, published study, toxicological property, biological, chemical, and physical property, product recall, warning statement, an industry best practice and a public comment associated with the at least one substance and product;
processing the received plurality of user notifications to extract data and populate at least one database, wherein the issue database includes data fields for at least one of development type of study, type of property, type of impact, geographical area, jurisdiction, type of action, topic, time, function, category and group of substance or product;
analyzing the data in the database extracted from the plurality of user-focused notifications with a computer program configured to prepare the plurality of user-focused notification for presentation to the user in a manner which permits visualization of trends; and
presenting human-readable trend visualization output to the user.

2. The method of claim 1, wherein
the plurality of user-focused notifications are received from a News Aggregator service.

3. The method of claim 2, wherein
the notifications are based on pre-defined subjects of user interest.

4. The method of claim 1, wherein
the output from the analysis of the data extracted from the plurality of user-focused notifications is presented in the form of a graph of a frequency of occurrence of developments relating to the at least one substance and product against at least one parameter of interest to the user, wherein the at least one parameter of interest includes at least one of geographical area, jurisdiction, type of action, topic, time, function, category and group of substance or product

5. The method of claim 1, wherein
the output from the analysis of the data extracted from the plurality of user-focused notifications is distributed over an electronic network to participants in at least one of a manufacturing process and a supply chain.

6. A system for computer-based issue analysis and trend visualization in at least one of manufacturing and supply chain management, comprising:
a networked computer, the network computer being configured to
receive at a network computer of a user a plurality of user-focused notifications of the existence of a developments relating to at least one of a substance and a product, wherein the developments include at least one of developments in a regulation, a standard, published study, toxicological property, biological, chemical, and physical property, product recall, warning statement, an industry best practice and a public comment associated with the at least one substance and product;
process the received plurality of user notifications to extract data and populate at least one database, wherein the issue database includes data fields for at least one of development type of study, type of property, type of impact, geographical area, jurisdiction, type of action, topic, time, function, category and group of substance or product;
analyze the data in the database extracted from the plurality of user-focused notifications with a computer program configured to prepare the plurality of user-focused notification for presentation to the user in a manner which permits visualization of trends; and
present human-readable trend visualization output to the user.

7. The system of claim 6, wherein
the plurality of user-focused notifications are received from a News Aggregator service.

8. The system of claim 7, wherein
the notifications are based on pre-defined subjects of user interest.

9. The system of claim 6, wherein the output from the analysis of the data extracted from the plurality of user-focused notifications is presented in the form of a graph of a frequency of occurrence of developments relating to the at least one substance and product against at least one parameter of interest to the user, wherein the at least one parameter of interest includes at least one of geographical area, jurisdiction, type of action, topic, time, function, category and group of substance or product

10. The system of claim 6, wherein
the output from the analysis of the data extracted from the plurality of user-focused notifications is distributed over an electronic network to participants in at least one of a manufacturing process and a supply chain.
